(19) United States
(12) Patent Application Publication
(10) Pub. No.: US 2002/0161881 A1
(43) Pub. Date: Oct. 31, 2002

(54) Array-configured packet analyzer

(75) Inventors: David Perkinson, Madison, AL (US); Michael J. Norton, Huntsville, AL (US)

Correspondence Address: CHRISTOPHER F. REGAN, ESQUIRE, ALLEN, DYER, DOPPELT, MILBRATH & GILCHRIST, P.A., P.O. Box 3791, Orlando, FL, 32802-3791, US

(73) Assignee: Adtran, Inc., Huntsville, AL (US)

(21) Appl. No.: 09/845,103

(22) Filed: Apr. 30, 2001

(51) Int. Cl. G06F 15/173

(52) U.S. Cl. 709/224; 709/223

(57) ABSTRACT

A packet analyzer for controlling a packet switch is segmented into a sequentially scanned array of packet analyzers, each of which is associated with a respectively different configuration function. When a packet is presented to the switch, a prescribed portion of the packet is sequentially coupled to the analyzers. As each analyzer examines the packet, it returns an indicator (e.g., ‘1’ or ‘0’) in accordance with whether the packet is associated with the configuration function of that analyzer. Once an analyzer indicates that it will accept the packet, the packet is forwarded to a stack associated with one or more virtual circuit ports embraced by that analyzer's configuration function, so that the packet may be forwarded to the appropriate virtual circuit output port, for transport over the network to a destination address. If the packet is not accepted by any analyzer prior to reaching the last analyzer of the array, the last analyzer will accept and destroy the packet to prevent memory overflow.

### FIELD OF THE INVENTION

The present invention relates in general to communication networks and systems employed for the transport of digital telecommunication signals, and is particularly directed to a new and improved array-based packet analyzer mechanism for controlling the coupling of packets between virtual circuit ports of a frame relay network packet switch.

### BACKGROUND OF THE INVENTION

Digital communication systems enable telecommunication service providers (for example, a competitive local exchange carrier (CLEC), such as an internet service provider (ISP)), to provide various types of high speed digital service over network circuits of an incumbent local exchange carrier (ILEC), such as a Bell operating company (RBOC), serving a number of customer premises equipments (CPEs) having a wide range of operational bandwidths and digital subscriber line termination capabilities. FIG. 1 shows a reduced complexity example of such a digital communication network architecture as comprising a PCM communication link (such as an optical fiber) 10, through which a network (cloud) 12 at a ‘west’ end of the link 10 transmits and receives digital telecommunication signals (e.g., packetized T3 traffic) with respect to customer premises equipments (CPEs) served by a remote termination site (RTS) 30 at an ‘east’ end of the PCM link 10.

In order to route packets among the virtual circuits of the network, the network commonly employs one or more frame relay-based packet switches, a simplified diagram of one of which is shown at 20 in FIG. 2 as having multiple input ports Pi-1, . . . , Pi-N and multiple output ports Po-1, . . . , Po-N thereof coupled to associated virtual circuits (VCs). To filter and selectively ‘steer’ packets through the frame relay switch 20, its associated control processor or packet distribution controller 22 is customarily programmed with a fully compiled packet analysis or ‘filtering’ routine, that is operative to analyze the contents of a respective packet presented to (an input port Pi-i of) the switch, and then selectively route the packet to the appropriate output port Po-j, based upon the results of that analysis.

Because there are many (internet) protocols and many schemes to encapsulate those protocols in frame relay, the packet switching software is typically complex and requires many lines of code. As a result, as protocols change, it becomes practically impossible to manage a fully compiled packet analysis routine, in terms of installing and running an all encompassing ‘super’ analyzer base code.

### SUMMARY OF THE INVENTION

In accordance with the present invention, this problem is successfully remedied by segmenting the overall packet analyzer into a plurality of individual discrete packet analyzers, each of which is associated with a respectively different configuration function. Pursuant to a non-limiting, but preferred embodiment, the packet analyzers are stored in the form of a sequentially scannable memory array, the contents and order of which are dynamically updatable. Whenever a respective packet is presented to the switch, a prescribed portion of the packet—some number of bytes (e.g., its internet protocol (IP) field)—is coupled to the respective analyzers of the switch's filter control array, in a prescribed order (e.g., sequentially).

As each analyzer examines the packet, it returns a prescribed indicator (e.g., a ‘1’ bit or accept, or ‘0’ for reject), in accordance with whether the packet is associated with the configuration function of that analyzer. Once an analyzer returns an indicator (‘1’) that it will accept the packet, the packet is forwarded to a stack associated with one or more virtual circuit ports embraced by that analyzer's configuration function, so that the packet may be forwarded to the appropriate virtual circuit output port, for transport over the network to a destination address.

If, on the other hand, the packet is not accepted by any analyzer prior to reaching the last analyzer of the array, the last analyzer will accept and destroy the packet to prevent memory overflow. A particularly useful benefit of the array-configuration of the fragmented packet analyzer of the invention is its ability to be easily updated and reconfigured (e.g., by simply replacing, deleting, adding to, and rearranging (reprioritizing) the analyzers of the array).

### BRIEF DESCRIPTION OF THE DRAWINGS

FIG. 1 is a reduced complexity example of a digital communication network architecture;

FIG. 2 is a simplified diagram of a frame relay-based packet switch; and

FIG. 3 diagrammatically illustrates an array-based packet analyzer mechanism in accordance with the present invention.

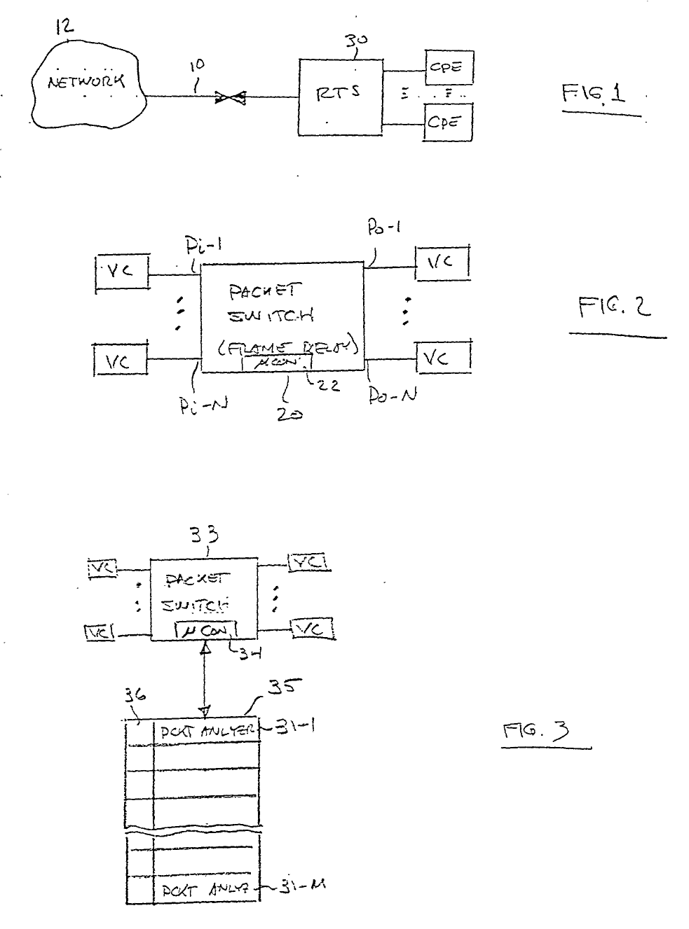

### DETAILED DESCRIPTION

Before describing in detail the new and improved array-based packet analyzer in accordance with the present invention, it should be observed that the invention resides primarily in what is effectively a prescribed communication control mechanism, that is executable by the hardware and software of supervisory communications control components of conventional digital communication circuitry, including digital signal processing components and attendant supervisory control circuitry therefor, that controls the operations of such circuits and components.

As a consequence, the configuration of such circuits and components and the manner in which they are interfaced with other communication system equipment have, for the most part, been illustrated by readily understandable block diagrams, which show only those specific details that are pertinent to the present invention, so as not to obscure the present disclosure with details which will be readily apparent to those skilled in the art having the benefit of the description herein. Thus, the diagrammatic illustrations are primarily intended to show the major components and functional operations of the invention in the context of a present day digital communication network in a convenient functional grouping, whereby the present invention may be more readily understood.

Referring now to FIG. 3, the array-based packet analyzer mechanism of the invention is diagrammatically illustrated as comprising a plurality of individual packet analyzers 31-1, . . . , 31-M, each of which is associated with a respectively different configuration function for controlling the port-coupling operation of a packet switch 33. As pointed out briefly above, in accordance with a non-limiting, but preferred embodiment, the packet analyzers 31 are stored in a sequentially scanned packet analyzer memory 35. This allows the overall packet analyzer mechanism used by the switch to be easily dynamically modified, by simply changing the contents of the array (e.g., replacement, deletion, addition, and rearrangement (reprioritization) of the individual packet analyzers.

In operation, as a packet is presented to a virtual circuit port of the switch 33, a prescribed portion of the packet—some number of bytes (e.g., an IP field)—is coupled by the switch's microcontroller (packet distribution controller) 34 to the respective analyzers 31 of the array 35 for analysis. As described above, coupling the packet to the packet analyzers stored in a sequential array provides a relatively efficient, and easily reprioritizable mechanism for filtering and forwarding the packet. As a respective analyzer examines the packet, it returns a prescribed indicator based upon whether or not it has a configuration function for which there is an associated virtual circuit coupled to the switch, and to which the packet may be routed (e.g., in accordance with (internet protocol) information contained in the packet).

For example, the analyzer may return, at a prescribed accept/reject bit location 36 thereof, a ‘1’ bit for true or accept, or a ‘0’ bit for not-true or reject. If a respective analyzer returns a ‘0’ bit, that analyzer has no corresponding configuration function and the routine then steps to the next analyzer of the array. This process continues until a ‘1’ bit is returned. Once a ‘1’ bit is returned (ostensibly indicating that the packet has been accepted for routing to a virtual circuit associated with the accepting packet analyzer's configuration function), processing of that packet by the packet array analyzer is completed.

To ensure that each packet presented for analysis is fully processed and appropriately disposed of, the last analyzer in the array is configured as a ‘termination’ function, the sole purpose of which is to discard the packet. In particular, if a packet transitions all the way through the entire array to the last (termination) function without a ‘1’ being returned for any virtual circuit associated analyzer function, the packet will then be accepted by the last analyzer. This analyzer is configured to return a ‘1’ bit, indicating that the packet has been accepted, so that the next packet may be processed. However, rather than providing for routing of the packet to an associated virtual circuit, the last (termination function) analyzer simply destroys the packet, to prevent memory overflow.

As will be appreciated from the foregoing description, the present invention effectively overcomes the updating and complexity problem of a conventional packet analysis routine by segmenting the packet analysis routine into a sequentially addressable array of individual discrete packet analyzers, each of which is associated with a respectively different configuration function, which facilitates modification of one or more portions of the packet analysis routine by replacing, deleting, adding to, and rearranging reprioritizing the individual analyzers of the array.

While we have shown and described an embodiment in accordance with the present invention, it is to be understood that the same is not limited thereto but is susceptible to numerous changes and modifications as known to a person skilled in the art, and we therefore do not wish to be limited to the details shown and described herein, but intend to cover all such changes and modifications as are obvious to one of ordinary skill in the art.

What is claimed

1. A method of selectively coupling digital communication packets, that are presented to virtual circuit input ports of a packet switch, through said switch to virtual circuit output ports thereof, said method comprising the steps of:
(a) providing a plurality of packet analyzers, a respective one of which is operative to analyze contents of a packet presented thereto and to provide an output representative of whether or not said contents of said packet contains prescribed information;
(b) coupling a packet presented to a respective virtual input port of said switch to respective ones of said plurality of packet analyzers; and
(c) in response to a respective packet analyzer to which a packet is presented in step (b) supplying an output representative that the contents of the packet coupled thereto in step (b) contains said prescribed information, coupling said respective packet to a selected virtual circuit output port of said switch, but otherwise not coupling said respective packet to a virtual circuit output port of said switch.

2. The method according to claim 1, wherein step (b) comprises coupling a packet presented to a respective virtual input port of said switch to a prescribed order of said plurality of packet analyzers, and step (c) comprises, in response to any packet analyzer of said prescribed order of said plurality of packet analyzers supplying said output representative that contents of the packet coupled thereto contains said prescribed information, coupling said respective packet to a selected virtual circuit output port of said switch, and terminating coupling of said packet to any remaining ones of said prescribed order of said plurality of packet analyzers.

3. The method according to claim 1, wherein step (c) comprises, in response to no packet analyzer having a configuration function for which there is an associated virtual circuit port of said switch, accepting the packet coupled thereto and discarding said packet.

4. The method according to claim 1, wherein
step (a) comprises providing a prescribed order of first through N−1th packet analyzers having configuration functions for there are associated virtual circuit ports of said switch, and an Nth packet analyzer having no configuration functions for there is an associated virtual circuit port of said switch,
step (b) comprises coupling said packet presented to a respective virtual input port of said switch to respective ones of said first through N−1th packet analyzers, and
step (c) comprises, in response to any of said first through N−1th packet analyzers supplying an output representative that the contents of the packet coupled thereto in step (b) contains said prescribed information, coupling said respective packet to a selected virtual circuit output port of said switch, but in response to none of said first through N−1th packet analyzers supplying an output representative that the contents of the packet coupled thereto in step (b) contains said prescribed information, causing said Nth packet analyzer to accept and discard said packet.

5. A packet switch control mechanism for controlling the selective coupling of digital communication packets presented to virtual circuit input ports of a packet switch to virtual circuit output ports thereof comprising:
a plurality of packet analyzers, a respective one of which is operative to analyze contents of a packet presented thereto and to provide an output representative of whether or not said contents of said packet contains prescribed information; and
a packet distribution controller coupled to said plurality of packet analyzers and being operative, in response to a respective packet analyzer supplying an output representative that the contents of the packet coupled thereto contains said prescribed information, to couple said respective packet to a selected virtual circuit output port of said switch, but otherwise not coupling said respective packet to a virtual circuit output port of said switch.

6. The packet switch control mechanism according to claim 5, wherein said packet distribution controller is operative, in response to any packet analyzer of a prescribed order of said plurality of packet analyzers supplying said output representative that contents of the packet coupled thereto contains said prescribed information, to cause said respective packet to be coupled to a selected virtual circuit output port of said switch, and to terminate further coupling of said packet to any remaining ones of said prescribed order of said plurality of packet analyzers.

7. The packet switch control mechanism according to claim 5, wherein said packet distribution controller is operative, in response to no packet analyzer having a configuration function for which there is an associated virtual circuit port of said switch, to causes said packet to be accepted and discarding.

8. The packet switch control mechanism according to claim 5, wherein said plurality of packet analyzers comprises a prescribed order of first through N−1th packet analyzers having configuration functions for there are associated virtual circuit ports of said switch, and an Nth packet analyzer having no configuration functions for there is an associated virtual circuit port of said switch, and wherein said packet distribution controller is operative, in response to any of said first through N−1th packet analyzers supplying an output representative that the contents of the packet coupled thereto contains said prescribed information, to couple said respective packet to a selected virtual circuit output port of said switch, and wherein said Nth packet analyzer is operative, in response to having said packet coupled thereto, to accept and discard said packet.
